(19) United States
(12) Patent Application Publication
(10) Pub. No.: US 2012/0177304 A1
(43) Pub. Date: Jul. 12, 2012

(54) SYSTEM FOR IMAGE INTELLIGENCE EXPLOITATION AND CREATION

(75) Inventor: James E. Taber, Garland, TX (US)

(73) Assignee: Raytheon Company, Waltham, MA (US)

(21) Appl. No.: 13/005,337

(22) Filed: Jan. 12, 2011

(51) Int. Cl. G06K 9/36

(52) U.S. Cl. 382/284

(57) ABSTRACT

In certain embodiments, an apparatus is provided that includes at least one computer-readable medium comprising code, that, when executed by at least one processor, is operable to: receive an image query, translate the image query to a server, receive an image based on the query from the server, receive image overlay data, and fuse the image overlay data with the image to create an image product.

### TECHNICAL FIELD

This disclosure relates generally to image exploitation and creation and more particularly to service-oriented systems for image exploitation and creation.

### BACKGROUND

Imaging annotation is an important tool in exploiting and synthesizing intelligence. Various methods have been used to fuse intelligence with images, but these methods can be human labor intensive and require proprietary tools that reside on the local workstation of an operator. Proprietary tools can be financially costly, impose computational intensive demands on the local workstation, and restrict the fused image product to a few proprietary formats.

### SUMMARY

In certain embodiments, an apparatus is provided that includes at least one non-transitory computer-readable storage medium comprising code, that, when executed by at least one processor, is operable to: receive an image query; translate the image query into a format understandable by a server; receive an image from the server based on the image query; receive image overlay data; and fuse the image overlay data with the image to create an image product. The image overlay data includes metadata and annotations in JSON object format. Fusing the image overlay data with the image to create an image product includes modifying the image received from the server by drawing the image overlay data at a location or time in the image specified by the JSON objects. Fusing the image overlay data with the image to create an image product includes modifying a header of the image file to include the image overlay data. Fusing the image overlay data with the image to create an image product includes creating a data file associated with the image, the data file containing the image overlay data. The code is further operable to: receive multiple image results from the server; return the image results to a client; receive an image selection from the client; order the image selection from the server; receive the selected image from the server; and return the image to the client. The client includes an autonomous application. The code is further operable to create the image product in a format selected by a client.

In other embodiments, a method is provided for creating an exploited image product that includes receiving, at a computer, an image query; translating, by the computer, the image query to a server; receiving, at the computer, an image from the server based on the image query; receiving, at the computer, image overlay data; and creating, by the computer, an exploited image product by fusing the image overlay data with the image. The image overlay data includes metadata, annotations, location data, or time data in JSON object format. The image overlay data with the image to create an image product includes drawing a graphic specified by the image overlay data at a location or time in the image specified by the image overlay data. Fusing the image overlay data with the image to create an image product includes modifying a header of the image file to include the image overlay data. Fusing the image overlay data with the image to create an image product includes creating a data file associated with the image, the data file containing the image overlay data. The method includes receiving, at the computer, multiple image results from the server; returning, by the computer, the image results to a client; receiving, by the computer, an image selection from the client; ordering, by the computer, the image selection from the server; receiving, at the computer, the selected image from the server; and returning, by the computer, the image to the client. The method includes creating, by the computer, the image product in a format selected by a client. The client includes an autonomous application.

In other embodiments, a system is provided that includes a client computer; a service computer in communication with the client computer; and an application server in communication with the service computer; wherein the service computer is operable to: receive an image query from the client computer; translate the image query to a format understandable by the application server; receive an image from the server based on the image query; receive image overlay data; and fuse the image overlay data with the image to create an image product. The service computer is further operable to create the image product in a format selected by the client, said formats selected from the group consisting of jpeg, gif, bmp, kmz, and NITF. Fusing the image overlay data with the image to create an image product includes modifying the image file. The client computer includes: an interface operable to send requests to the service computer and receive request results from the service computer; and a viewer operable to display request results on the client computer.

Certain embodiments of the present disclosure may provide one or more technical advantages. In certain embodiments, a computer service may provide query services and autonomously fuse images with annotation information and metadata using open communication standards. This type of configuration can reduce the processing load on client workstations and reduce the amount of redundant software associated with other image exploitation systems

Certain embodiments of the present disclosure may provide some, all, or none of the above advantages. Certain embodiments may provide one or more other technical advantages, one or more of which may be readily apparent to those skilled in the art from the figures, descriptions, and claims included herein.

### BRIEF DESCRIPTION OF THE DRAWINGS

For a more complete understanding of the present disclosure and its advantages, reference is made to the following descriptions, taken in conjunction with the accompanying drawings, in which:

FIG. 1 illustrates a system diagram according to some embodiments of the present disclosure.

FIG. 2 illustrates communications between the entities illustrated in the system diagram of FIG. 1 to create an exploited image product according to some embodiments of the present disclosure.

FIG. 3 illustrates communications between the entities illustrated in FIG. 1 to create an exploited image product according to other embodiments of the present disclosure.

### DESCRIPTION OF EXAMPLE EMBODIMENTS

It should be understood at the outset that, although example implementations of embodiments are illustrated below, various embodiments may be implemented using any number of techniques, whether currently known or not. The present disclosure should in no way be limited to the example implementations, drawings, and techniques illustrated below. Additionally, the drawings are not necessarily drawn to scale.

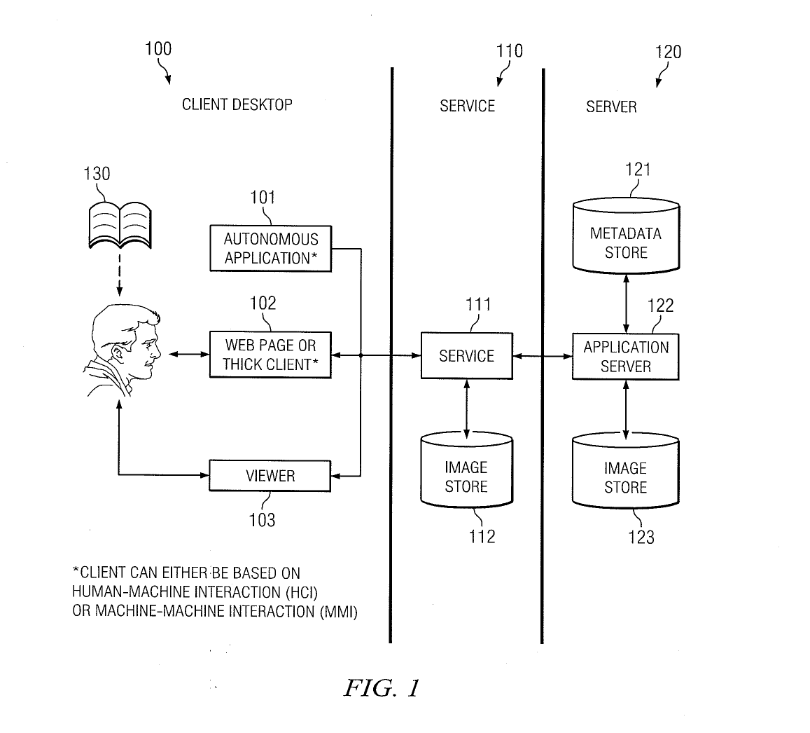

FIG. 1 is a diagram of one embodiment of an image exploitation system according to the teachings of the present disclosure. Client 100 of FIG. 1 can be a user's local workstation 130, a personal computer, or an autonomous application 101. Client 100 can include a web browser with access to a web page that interacts with Service 110. In addition, Client 100 can include a client application that interacts with Service 110. Viewer 103 can be an image viewer application such as Google Earth or an NITF viewer that can be installed on Client 100 and used to view images and fused image products.

Client 100 can be connected to Computer 110 over a network connection or any other type of connection between computer systems known in the art. Computer 110 can be a computer, a part of a computer, or a collection of computers with application service 111 installed. Computer 110 can include a processor that can execute code stored on a non-transitory storage media. Application service 111 can be in communication with an image store 112 through a direct electrical or network connection. Image store 112 can be contained in the memory storage portion of computer 110, a separate computer, or any other storage device accessible over a network or other electronic communication means.

Computer 110 can be in communication with Server 120 through networked communication or any other electronic communication means. Server 120 can be a computer or collection of computers in communication with one another. Server 120 can include an application server 122, which can be installed as a software application within a computer comprising Server 120 or can be standalone computer. Service 111 can be in communication with application server 122. Application server 122 can be in communication with image store 123.

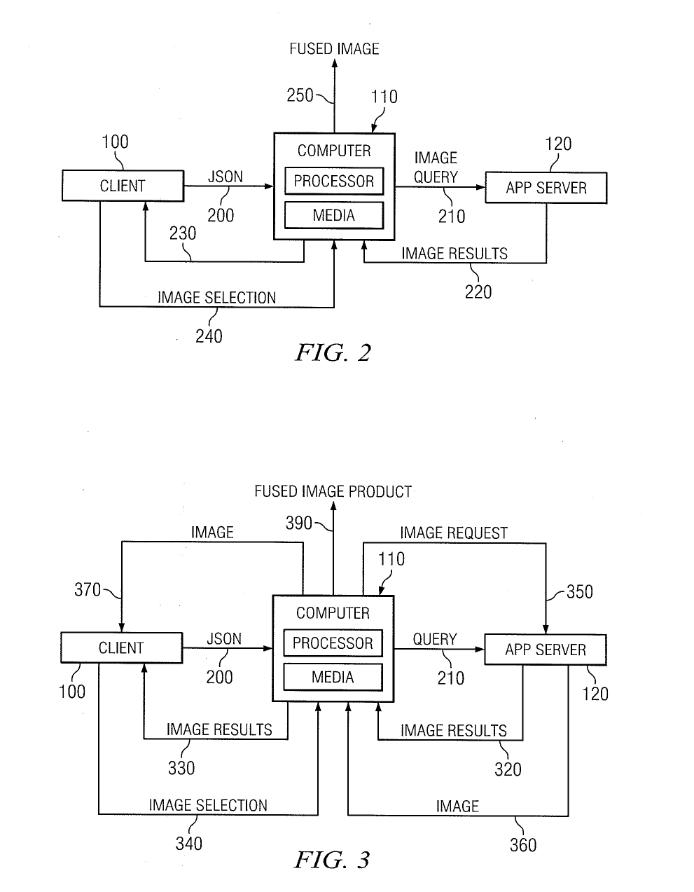

FIG. 2 shows the communications between some of the entities illustrated in FIG. 1 according to some embodiments of the present disclosure.

According to FIG. 2, image overlay data 200 can be fused with an image to create an intelligence exploitation object. The image overlay data can include metadata including symbols or annotation data including text. According to some embodiments, the process of creating a fused image begins with client 100 sending an image query and/or image overlay data 200 to computer 110 in the form of JavaScript Object Notation or JSON strings, for example. The image overlay data 200 can be in the form of key value pairs. The image overlay data 200 can originate from the client 100 or from another source entirely. Client 100 can use a web based interface or a locally installed client program to generate and/or send this query and image overlay data.

The image query 200 can be a request for a specific image file or files or a set of search criteria to be used to return a set of images satisfying the criteria. The image overlay data 200 can include a series of key value pairs that include annotations, images, timestamps, symbols, or icons to be added to an image file that is being queried or requested. The symbols, for instance, can be MIL-STD symbology. In addition, the image overlay data can also include time data or geolocation information such as longitude and latitude that are associated with the annotations, images, timestamps, symbols, or icons to form key value pairs. The geolocation information can indicate where, in the case of a geographic image, the associated annotation, image, timestamp, symbol, or icon should be combined with the queried or requested image. The time information can be used in situations where a fused video image product needs to be generated. The time information can be used to determine when and/or how long an icon or annotation should be displayed and included in the video. Request 200 can be generated manually by a client user, or can be generated autonomously by an intelligent alert system.

Upon receipt of query and/or image overlay data 200, computer 110 can use service 111 (not explicity illustrated in FIG. 2) to interpret the image query and send a translated image query 210 to the application server 120. The query can be translated to the communication protocol of the application server. The application server 120 executes the query against entries in the image store 123. The application server 120 then delivers the result 220 of the query to the computer 110. In the case where a single image is requested and returned, computer 110 and/or service 111 can fuse the image with portions of the image overlay data 200 received from client 100. In some embodiments, the geolocation information associated with metadata or annotations can be converted to a pixel location or pixel space of the returned image. Computer 110 and/or service 111 uses the pixel location or pixel space to identify where in the image to add the annotations or image icons. For instance, the pixel space in geographic images can be associated with longitude and latitude coordinates. This would allow associated geolocation information that is also provided in the form of longitude and latitude to be mapped to the pixel space of the image. Computer 110 and/or service 111 can subsequently create a fused image by adding or drawing the annotations or image icons to the locally stored retrieved image at the locations specified by the geolocation data. Computer 110 and/or service 111 can also add any arrows or other identifiers to connect the annotation to areas of the image or particular pixels in the image. In addition, computer 110 and/or service 111 can draw error ellipses using the pixel space.

This fused image 250 can then be saved by computer 110 and/or service 111 and stored locally, sent to client 100, or stored at any other location capable of storing electronic files, such as network servers or data centers. This type of fused image creation can be done when the client selects a jpeg image to be created. Computer 110 and/or service 111 can save the fused image in any format, such as a jpeg, bmp, or gif file or any other image file known in the art, specified by the client 100 in the client's initial request 200, or in a subsequent query to the client 100 after the fused image is created.

In some embodiments of the present disclosure, client 100 can request a fused image in NITF or EMZ format. In the event a NITF format is selected for the fused image, computer 110 and/or service 111 can edit the header of the NITF image to include the image overlay data 200. This file can be returned to the client 100 and viewed on a NITF viewer. Viewer 103 can be an NITF viewer. The NITF viewer displays the image with the image overlay data using the modified NITF header. In the event a file type such as a kmz file is requested for the fused image, computer 100 and/or service 111 can create a text file such as .doc file that includes the image overlay data. The text file can be included with the returned image file from the application server to the client. In the event the viewer 103 is a kmz viewer application, such as Google Earth, the kmz viewer can display the image with the image overlay data using the created or modified text file.

FIG. 3 shows the communications between some of the entities illustrated in FIG. 1 according to some embodiments of the present disclosure. According to FIG. 3, multiple image selections 320 are returned from server 120 to computer 110, which then translates and returns the results 330 to the client 100 as JSON objects. The client 100 can review the image results 330 and select the image it wishes to order. This selection 340 is sent to computer 110, which then retrieves the image from the application server. It some embodiments, computer 110 and/or service 111 can create a fused intelligence product according the present disclosure discussed previously in reference to FIG. 2. In other embodiments, computer 110 and/or service 111 can return the image 370 to the client 100. In these embodiments, the client can review the image either through a human user or an autonomous application, identify image overlay data of interest to overlay on the image, and determine an output format for the final fused image. As described in reference to FIG. 2, the image overlay data 200 can include metadata such as symbols or include annotations to an image. This data can include associated geolocation data or time data to form key value pairs. These steps can be done via a web interface or a locally installed client application. The web interface or installed client application can transmit the image overlay data as JSON objects to the computer 110. Computer 110 and/or service 111 can then create the fused and exploited image product by drawing the image overlay data onto the image in places and times indicated by the key value pairs. This can be the case when a jpeg fused image is requested. The fused and exploited image product can also be created by modifying the header of an image file (such as for a NITF image file) or creating or editing associated data files to the image (such as a text file) to allow a viewer application to overlay the metadata or annotations (such as for kmz image files). Computer 110 and/or service 111 can determine the locations in the image to overlay metadata using associated key value pair data, as discussed in reference to FIG. 2.

Although the present invention has been described with several embodiments, diverse changes, substitutions, variations, alterations, and modifications may be suggested to one skilled in the art, and it is intended that the invention encompass all such changes, substitutions, variations, alterations, and modifications as fall within the spirit and scope of the appended claims.

What is claimed is:

1. An apparatus, comprising:
at least one non-transitory computer-readable storage medium comprising code, that, when executed by at least one processor, is operable to:
receive an image query;
translate the image query into a format understandable by a server;
receive an image from the server based on the image query;
receive image overlay data; and
fuse the image overlay data with the image to create an image product.

2. The apparatus of claim 1 wherein the image overlay data comprises metadata and annotations in machine parsable format.

3. The apparatus claim 2 wherein fusing the image overlay data with the image to create an image product comprises modifying the image received from the server by drawing the image overlay data at a location in the image specified by the image overlay data.

4. The apparatus of claim 1 wherein fusing the image overlay data with the image to create an image product comprises modifying a header of the image file to include the image overlay data.

5. The apparatus of claim 1 wherein fusing the image overlay data with the image to create an image product comprises creating a data file associated with the image, the data file containing the image overlay data.

6. The apparatus of claim 1 wherein the code is further operable to:
receive multiple image results from the server;
return the image results to a client;
receive an image selection from the client;
order the image selection from the server;
receive the selected image from the server; and
return the image to the client.

7. The apparatus of claim 6 wherein the client comprises an autonomous application.

8. The apparatus of claim 1 wherein the code is further operable to create the image product in a format selected by a client.

9. A method for creating an exploited image product, comprising:
receiving, at a computer, an image query;
translating, by the computer, the image query to a server;
receiving, at the computer, an image from the server based on the image query;
receiving, at the computer, image overlay data; and
creating, by the computer, an exploited image product by fusing the image overlay data with the image.

10. The method of claim 9 wherein the image overlay data comprises metadata, annotations, location data, or time data in JSON object format.

11. The method of claim 9 wherein fusing the image overlay data with the image to create an image product comprises drawing a graphic specified by the image overlay data at a location in the image specified by the image overlay data.

12. The method of claim 9 wherein fusing the image overlay data with the image to create an image product comprises modifying a header of the image file to include the image overlay data.

13. The method of claim 9 wherein fusing the image overlay data with the image to create an image product comprises creating a data file associated with the image, the data file containing the image overlay data.

14. The method of claim 9 further comprising:
receiving, at the computer, multiple image results from the server;
returning, by the computer, the image results to a client;
receiving, by the computer, an image selection from the client;
ordering, by the computer, the image selection from the server;
receiving, at the computer, the selected image from the server; and
returning, by the computer, the image to the client.

15. The method of claim 9 further comprising:
creating, by the computer, the image product in a format selected by a client.

16. The method of claim 15 wherein the client comprises an autonomous application.

17. A system, comprising:
a client computer;
a service computer in communication with the client computer; and
an application server in communication with the service computer;
wherein the service computer is operable to:
receive an image query from the client computer;
translate the image query to a format understandable by the application server;
receive an image from the server based on the image query;
receive image overlay data; and
fuse the image overlay data with the image to create an image product.

18. The system of claim 17 wherein the service computer is further operable to create the image product in a format selected by the client, said formats selected from the group consisting of jpeg, gif, bmp, kmz/kml, and NITF.

19. The system of claim 17 wherein fusing the image overlay data with the image to create an image product comprises modifying the image file.

20. The system of claim 17 wherein the client computer comprises:
an interface operable to send requests to the service computer and receive request results from the service computer; and
a viewer operable to display request results on the client computer.
